(19) United States
(12) Patent Application Publication
(10) Pub. No.: US 2008/0240375 A1
(43) Pub. Date: Oct. 2, 2008

(54) Method Of Processing Multiple Ring Back Tone In Voice Service Application Based On Sip Fork

(76) Inventor: Jian Chen, Guangdong Province (CN)

Correspondence Address: CALFEE HALTER & GRISWOLD, LLP, 800 SUPERIOR AVENUE, SUITE 1400, CLEVELAND, OH, 44114, US

(21) Appl. No.: 11/914,467

(22) PCT Filed: May 19, 2005
(86) PCT No.: PCT/CN05/00693

§ 371 Date: Jan. 29, 2008

(51) Int. Cl. H04M 1/64

(52) U.S. Cl. 379/87

(57) ABSTRACT

A signaling-based processing method is presented, which is based on the influence of early media (a ring back tone or a voice notice before a session is established) from multiple called participants on the calling participant in SIP FORK-based voice service, which ensures the calling participant not to receive early media of multiple called participants at the same time.

### FIELD OF THE INVENTION

The present invention belongs to the field of communications. Specifically, the present invention relates to a method of processing multiple ring back tones in SIP FORK-based voice service application.

### DESCRIPTION OF THE BACKGROUND ART

SIP (Session Initial Protocol, RFC3261) uses the offer/answer model (RFC3264) to exchange the SDP (Session Description Protocol, RFC2327) of two participants concerned in a session, including the various attributes of a media stream to be created, such as the IP address of the media stream, the various ports of the transport layer and the various encodings used, etc. In a general session, a calling participant transmits a SDP message of the calling participant to a called subscriber by means of a session request message INVITE, and after the called subscriber answers, the called participant sends back an answer response 200 to transmit a negotiated SDP of the called participant to the calling participant. The exchange of SDP meets a process of offer/answer. When a offer participant (e.g. the above-mentioned calling participant) gives an offer, a offer participant can generally receive a corresponding media information (RFC3264, section 5.1), thus avoiding a media clipping. Because a SIP-based session signaling is completely separated from the transmission of media, the signaling usually is routed over several proxies, but the transmission of media is usually end to end. Therefore, when the called subscriber is off hook, the media information generally reaches the calling subscriber earlier than the answer response (200).

In the general session, when the called participant receives a call establishment request from the calling participant, if the called subscriber is available, the called participant will send an alert instruction. In PSTN, a switch at a destination station plays the ring back tone to the calling subscriber (Q764, section 2.1.4.7). In a SIP network, owing to the diversity of media information and user agents (UA), the called participant does not play the ring back tone to the calling participant. After receiving the alert instruction (180 response in SIP), the calling participant can simulate the PSTN network to locally play a ring back tone, or it may use other ways, such as representing by text or animated cartoon . After SIP is introduced into the telecommunication network, if the called participant is an SIP subscriber, the calling participant locally plays the ring back tone (which is called local play) generally; and if the called participant is a PSTN subscriber, the called participant plays the ring back tone (which is called a remote play). In a simple two-participant session, when the calling participant is an SIP subscriber, it is all right to use both the local play and the remote play (Q1912, SIP5 stipulates that if the 180 message does not include SDP, the calling participant locally plays the ring back tone, otherwise, a remote play is carried out). However, in SIP FORK application, one calling participant corresponds to a plurality of called participants (one called subscriber having a plurality of accessing addresses, such as a plurality of numbers), so when a plurality of called participants are in the PSTN network, the switch at the destination station can directly plays the ring back tone to the calling participant through the interworking unit (IWU) owing to the end-to-end attribute of the media. In this case, since the calling participant cannot mix the tones, the subscriber usually hears odd noises.

With respect to the early media problem in SIP FORK application, G. Camarillo, H. Schulzrinne believes that UAC (UA client) should select one of the early media from different UAS (UA server) and suppress the rest of them, but he does not expound the strategy for selection (see draft-ietf-sipping-early-media-02.txt). The applicant believes that the solution of selecting one and suppressing the rest may make a wrong selection on the one hand, and on the other hand, it is hard to be applied due to the complexity in processing, such as early media detection, selection, suppression, recovery (the suppressed participant is the final session participant, and the media stream must be recovered at this time).

The SIP FORK-based voice service can simplify the processing of SIP FORK early media. No matter which network the called participant falls in, as long as there is a called ringing tone, the calling participant can locally play the ring back tone (in practical use, the application server can even instruct the calling participant to play the ring back tone before FORK, and this is especially important to serial addressing of the FORK application). Different from the RFC3261 prescription that SIP PROXY routes all the 18X messages of the called participant to the calling participant before receiving the answer response 200, where the SIP PROXY masks all the 18X messages of the called participant and generates a message 180 by itself to instruct the calling participant to locally play the ring back tone (see FIG. 1, cited from part III (Signaling Flow) of SIP criterion of China Telecom). The applicant believes that although this does not comply with RFC3261, it is still advisable from the point view of application in such isomorphic network as PSTN, since an indication regarding a call progress is always represented by the ring back tone. Of course, it would be possible that some services will be lost, such as colorful ring back tones and the like.

The above flow process only describes a signaling message, but it does not give any account for the more serious early media. Because the transmission of media is independent from signaling, although signaling is suppressed, media (ring back tone or voice prompt) from different called participants can still reach the calling participant. Therefore, how to suppress the early media from multiple called participants is comparatively more important. However, no agreement has been reached on this by now. Some believe that the media information can be received only after the calling subscriber receives the answer response 200, and others believe that DSP should have a packet filtering function, and that before the calling subscriber receives the answer message 200 (herein the answer message 200 carries the SDP information of the called participant), even if media information is received, DSP should discard it (because the calling participant does not know the sending address of the called participant at this time).

In fact, no matter which method is used, it either violates the offer/answer principle, or has special requirement on DSP, and even worse, it affects the separation of service and call control.

### SUMMARY OF THE INVENTION

In order to solve the problems existing in the above described prior art, the present invention provides two protocol control-based methods, which appropriately change the signaling content and flow process by means of the Soft Switch (SW, in practical implementation, it can be SIP PROXY, B2BUA or a combination of them) at the service triggering places, so that the path in the backward direction of the media path cannot be completely established before the called participant answers under the the protocol specification, thus avoiding the calling subscriber receiving early media from different called participants.

According to one aspect of the present invention, a method of processing multiple ring back tones in SIP FORK-based voice service application is provided, the method comprising the steps of

sending the session request message INVITE from the calling participant to the soft switch;

the soft switch receiving said INVITE, triggering the FORK service and checking the Session Description Protocol (SDP) of the calling participant;

the soft switch sending INVITE message with the changed calling SDP to all the called participants, and sending a response to the calling participant, wherein the response instructs the calling participant to locally play the ring back tone;

the interworking unit IWU which functions as an intermediate station receiving said INVITE, and through-connecting the path in the forward direction of the media without through-connecting the path in the backward direction thereof;

the switch at the destination station playing the ring back tone to the calling participant if the called subscriber is available, wherein said ring back tone terminates at the interworking unit;

the soft switch receiving the answer response if a certain called participant is off hook, and releasing other un-answered calls and acknowledging the receipt of the answer response;

the soft switch sending to the called participant the INVITE message with unchanged calling SDP so as to restart the SDP negotiation;

establishing a bi-directional media connection between the called participant and the calling participant.

According to another aspect of the present invention, a method of processing multiple ring back tones in SIP FORK-based voice service application is provided, the method comprising the steps of

sending the session request message INVITE from the calling participant to the soft switch;

the soft switch receiving said INVITE, triggering the FORK service and sending to the calling participant a prompt response with a media connection establishment being rejected so as to reject establishment of media path;

the calling participant closing the backward path after receiving said prompt response;

the soft switch sending to all the called participants the INVITE request including the SDP information of the calling participant;

the interworking unit IWU which functions as an intermediate station through-connecting the forward and backward media paths after receiving the INVITE message;

the switch at the destination station playing the ring back tone to the calling participant if the called subscriber is available;

the destination station sending to the soft switch the prompt response with the SDP of the called participant, and the soft switch receiving and holding said SDP of the called participant;

the IWU sending the answer response to the soft switch if a certain called participant is off hook, and the soft switch releasing other un-answered calls upon receiving said answer response;

the soft switch sending to the calling participant the answer response without the SDP information;

the soft switch sending to the calling participant the INVITE to restart the SDP negotiation;

the calling participant sending back the answer after receiving the offer, and meanwhile through-connecting the media path, thus completely establishing the media path between the called participant and the calling participant.

### DESCRIPTION OF THE DRAWINGS

FIG. 1 shows a method of processing multiple ring back tones in SIP FORK-based voice service application in the prior art;

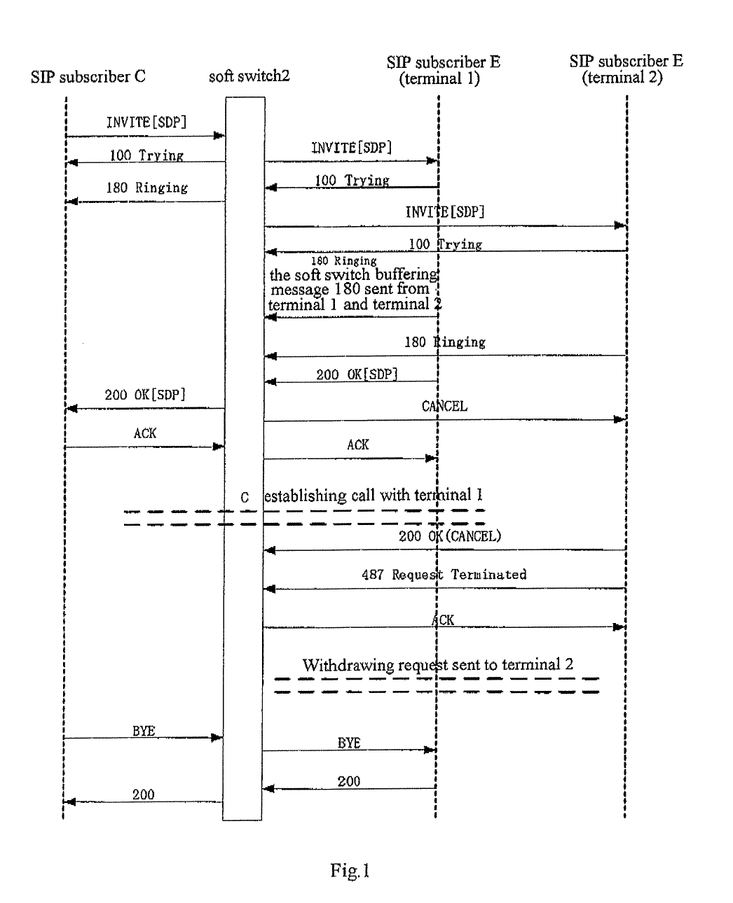

FIG. 2 shows a method of processing multiple ring back tones in SIP FORK-based voice service application according to the first embodiment of the present invention; and

FIG. 3 shows a method of processing multiple ring back tones in SIP FORK-based voice service application according to the second embodiment of the present invention.

### DESCRIPTION OF THE PREFERRED EMBODIMENTS

Two preferred embodiments of the present invention are described below with reference to the drawings.

### Embodiment 1: How to Suppress the Establishment of Backward Path at the Called Participant

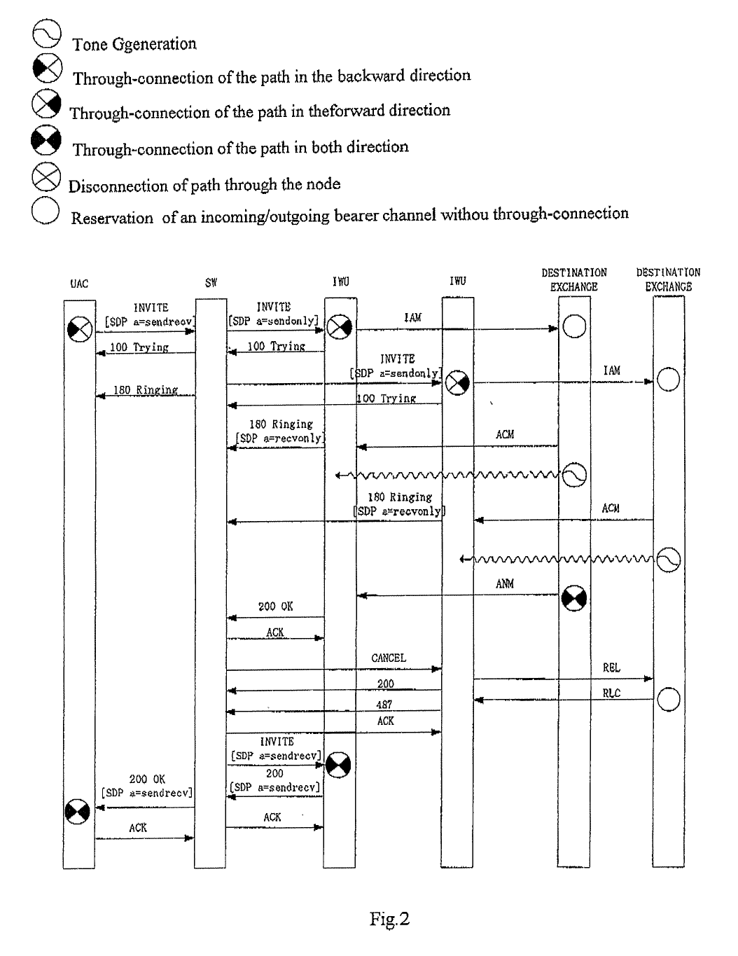

FIG. 2 shows a method of processing multiple ring back tones in SIP FORK-based voice service application according to the first embodiment of the present invention, i.e., the method of suppressing the establishment of backward path at the called participant.

Taking the case where the called participant falls in a PSTN network as an example, when the soft switch receives the INVITE message from the calling participant (which is represented by UAC, i.e. user agent of the client, including SIP terminal, SIP PROXY, B2BUA or SIP/ISUP interworking unit IWU) and triggers the FORK service, it checks the calling SDP. If the direction attribute of the media stream is a=sendrecv, it is changed into a=sendonly (in a normal call, the media stream direction attribute of the SDP of the calling participant is a=sendrecv), which indicates that the calling participant can only send media information but cannot receive media information. The soft switch must hold the calling SDP contents.

The soft switch sends INVITE message with the changed calling SDP to all the called participants.

The soft switch sends a response 180 to the calling participant so as to instruct the calling participant to locally play the ring back tone, wherein said response does not carry the SDP.

After the interworking unit receives the INVITE request, it checks the SDP information. Since the direction attribute of media stream in SDP is sendonly, the IWU which functions as an intermediate station will not through-connect the backward path of the media (RFC3264, section 8.1), but will through-connect the forward path of the media (Q764, section 2.1.2).

If the called subscriber is available, the switch at the destination station plays the ring back tone to the calling participant. At this time, since the backward path of the media has not been completely established yet, the early media like the ring back tone or the voice notice cannot reach the calling subscriber.

The soft switch receives ringing response 180 with SDP, but doesn't process it.

If some called participant is off hook, then the soft switch receives the answer response 200, releases other un-answered calls and then acknowledges the receipt of the answer response.

The soft switch sends the INVITE message to the called participant to restart the SDP negotiation. The SDP carried in the INVITE is the SDP of the calling participant it has held. At this time, the direction attribute in SDP is a=sendrecv.

Upon receiving the offer, the IWU sends back an answer to the soft switch and through-connects the backward path at the same time. Then the backward path on the media path is completely established, and the calling participant can receive the media information of the called participant.

Upon receiving the 200 of IWU, the soft switch sends an answer response 200, which carries the SDP of the called participant, to the calling participant.

The calling participant sends an answer acknowledgement, and then the signaling message finishes at this time. The forward path on the media path is completely established, so the called path can receive the media information of the calling participant.

### Embodiment 2: How to Suppress the Establishment of the Backward Path at the Calling Participant

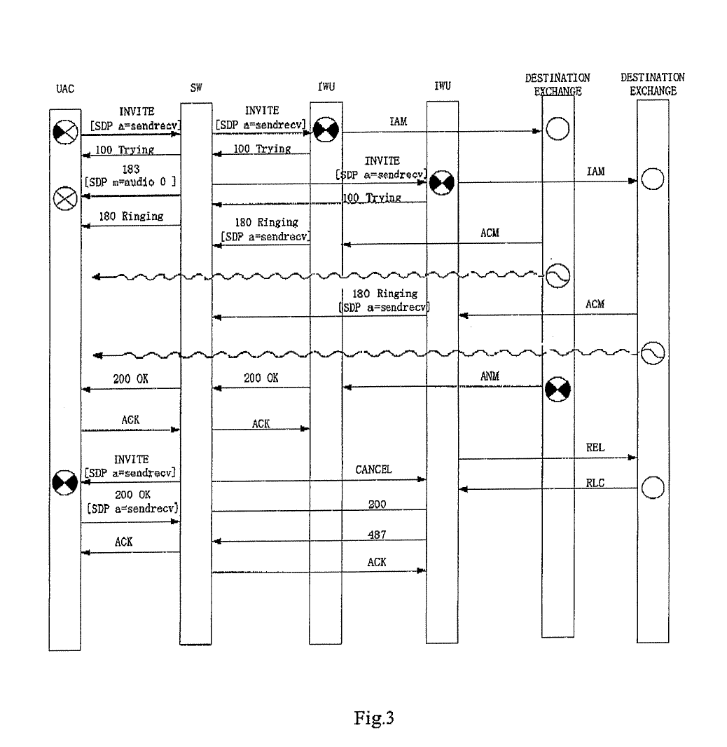

FIG. 3 shows a method of processing multiple ring back tones in SIP FORK-based voice service application according to the second embodiment of the present invention, i.e. a method for suppressing establishment of the backward path at the calling participant.

Taking the case where the called participant falls in a PSTN network as an example, the soft switch receives the INVITE message from the calling participant and triggers the FORK service and sends back a response 180 to the calling participant. The response 180 includes SDP which rejects the establishment of the media path of the calling participant (RFC3264, Chapter 6, when rejecting a media stream, the port number in the corresponding media stream in the responding SDP is set to be 0). To avoid confusion, SDP can be carried by 183 to reject the establishment of the media path. The response 180 only instructs the calling participant to locally play the ring back tone.

Upon receiving the refuse answer, the calling participant closes the backward path.

The soft switch sends the INVITE request to all the called participants, wherein the INVITE request includes the SDP information of the calling participant.

Upon receiving the INVITE message, the interworking unit, which functions as an intermediate station, through-connects the forward and backward media paths.

When the called subscriber is available, the switch at the destination station plays the ring back tone to the calling participant. At this time, since the backward path of the media of the calling participant is not through-connected, the early media like ring back tone or other voice notice cannot reach the calling subscriber.

The soft switch receives the called ringing response 180 with the SDP and then holds said called SDP.

If a certain called participant is off hook, then the IWU sends an answer response 200 to the soft switch. The soft switch releases other unanswered calls after receiving message 200.

The soft switch sends the answer response 200 to the calling participant, wherein the message 200 does not include SDP information.

The soft switch sends the INVITE message to the calling participant to restart SDP negotiation, and the SDP content is the held SDP information of the off-hook called participant.

After receiving an offer, the calling participant sends back an answer, and through-connects the media path at the same time, so that the media path between the calling participant and the called participant are completely established at this time.

According to the above description, the present invention is completely based on the standard protocol, and the control of signaling flow completely focuses on the service triggering point, and is completely transparent to both the calling participant and the called participant, so it is good for popularization of the service and the interconnection and interworking between various devices from different manufacturers.

In addition, since the media negotiation needs to be restarted after the called participant is off hook, media loss might be caused. But since the process of re-negotiation is very fast, media loss should be within an acceptable range.

While the invention has been described in conjunction with the specific embodiments, those skilled in the art shall understand that the invention can be practiced in different ways without departing from the spirit and principle of the invention. Therefore, the scope of the invention is not limited to the above described embodiments, but is defined by the appending claims.

1. A method of processing multiple ring back tones in SIP FORK-based voice service application, the method comprising the steps of
sending a session request message INVITE from a calling participant to a soft switch;
the soft switch receiving the INVITE, triggering a FORK service and checking a Session Description Protocol SDP of the calling participant;
the soft switch sending a INVITE message with a changed calling SDP to all the called participants, and sending a response to the calling participant instructing the calling participant to locally play the ring back tone;
an interworking unit IWU that functions as an intermediate station receiving said INVITE, and through-connecting the path in the forward direction of the media without through-connecting the path in the backward direction thereof;
the switch at a destination station playing the ring back tone to the calling participant if the called subscriber is available;
the soft switch receiving the answer response if a certain called participant is off hook, and releasing other un-answered calls and acknowledging the receipt of the answer response;
the soft switch sending to the called participant the INVITE message with the unchanged calling SDP so as to restart the SDP negotiation;
the called participant receiving the media information from the calling participant.

2. The method of processing according to claim 1, wherein the step of checking the Session Description Protocol SDP of the calling participant includes:
if the direction attribute of the media stream is a=sendrecv, changing it into a a=sendonly, which indicates that the calling participant can only send media information but cannot receive the media information.

3. The method of processing according to claim 1, wherein the soft switch holds the calling SDP contents after receiving said INVITE.

4. The method of processing according to claim 1, wherein the step of restarting SDP negotiation includes:
upon receiving the proposed offer from the soft switch, the IWU sends back an answer to the soft switch, and through-connects the path in the backward direction at the same time;
upon receiving the response from the IWU, the soft switch sends an answer response with the SDP of the called participant to the calling participant;
the calling participant sends and answer acknowledgement.

5. A method of processing multiple ring back tones in SIP FORK-based voice service application, the method comprising the steps of:
sending a session request message INVITE from a calling participant to a soft switch;
the soft switch receiving said INVITE, triggering a FORK service and sending to the calling participant a prompt response rejecting media connection establishment so as to reject establishment of media path;
the calling participant closing a path in the backward direction after receiving said prompt response;
the soft switch sending to all the called participants the INVITE request including the SDP information of the calling participant;
the interworking unit IWU which functions as an intermediate station through-connecting the paths in both the forward direction and the backward direction of media paths after receiving the INVITE message;
the switch at a destination station playing the ring back tone to the calling participant if the called subscriber is available;
the destination station sending to the soft switch the prompt response with the SDP of the called participant, and the soft switch receiving and holding said SDP of the called participant;
the IWU sending the answer response to the soft switch if a called participant is off hook, and the soft switch releasing other un-answered calls upon receiving said answer response;
the soft switch sending to the calling participant the answer response without the SDP information;
the soft switch sending to the calling participant the INVITE to restart the SDP negotiation;
the calling participant sending back an answer after receiving an offer, and meanwhile through-connecting the media path, thus completely establishing the media path between the called participant and the calling participant.

6. The method of processing according to claim 5, wherein said prompt response carries SDP to reject the establishment of media path, and only instructs the calling participant to play the ring back tone.

7. The method of processing according to claim 2, wherein the soft switch holds the calling SDP contents after receiving said INVITE.

8. The method of processing according to claim 2, wherein the step of restarting SDP negotiation includes:
upon receiving the proposed offer from the soft switch, the IWU sends back an answer to the soft switch, and through-connects the path in the backward direction at the same time;
upon receiving the response from the IWU, the soft switch sends an answer response with the SDP of the called participant to the calling participant;
the calling participant sends and answer acknowledgment.
